(19) United States
(12) Patent Application Publication
(10) Pub. No.: US 2014/0368045 A1
(43) Pub. Date: Dec. 18, 2014

(54) Power Management and Energy Storage Method

(71) Applicant: Ronald David Conry, Tallahassee, FL (US)

(72) Inventor: Ronald David Conry, Tallahassee, FL (US)

(21) Appl. No.: 13/919,242

(22) Filed: Jun. 17, 2013

(51) Int. Cl. H02J 4/00

(52) U.S. Cl. CPC H02J 4/00
USPC 307/75

(57) ABSTRACT

A method for improving grid power quality despite the presence of rapidly changing loads and a rapidly changing supply. The inventive method includes an energy generation mode that is used when grid demand is relatively high and an energy storage mode that is used when the energy supply exceeds the grid demand. The method is able to rapidly switch between the two modes. In the energy storage mode some of the energy available from a source is transferred to a storage unit. In the energy generation mode, available energy and stored energy is transferred to the grid.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of energy. More specifically, the invention comprises a method for improving grid power quality by countering the effects of rapidly changing supply and loads.

2. Description of the Related Art

Electrical power distribution grids have been in common use for over a century. Energy has traditionally been supplied to a grid by large power plants. Most such power plants use a steam-based heat engine to drive a prime mover (typically a steam turbine). The turbine drives a synchronous AC generator. The heat source used for driving the heat engine is typically coal, natural gas, or a nuclear reaction.

Hydroelectric power is the main traditional alternative to power plants using heat engines. In a hydroelectric installation, hydraulic head replaces pressurized steam in driving a turbine. The conversion of the rotating energy of the turbine into electrical energy is essentially the same, however, as for the process involving a heat engine.

An electrical grid encompasses the power generating plants, the distribution network, and the loads connected to the distribution network. A long-standing challenge in this field has been matching the current level of power generation to the current load placed on the grid. As those skilled in the art will know, if load increases while the available level of generation remains constant, the voltage will drop. This phenomenon is sometimes known as “brown out.”

FIG. 2 graphically illustrates the fluctuation of voltage on a power grid over time. The figure shows only a single phase of a 3-phase grid in which the nominal voltage is 480 VAC. Line voltage 34 varies over time, though its average is close to the nominal value of 480 VAC.

FIG. 3 illustrates transient phenomena which are also seen in prior art grids. Loading event 22 represents a major load coming on line. In this example the amount of supplied power remains constant. Thus, the voltage of the phase shown drops when loading event 22 occurs.

Some time later transient event 23 occurs. An example of a transient event would be the failure of a large distribution network because of an electrical storm. The sudden removal of this load causes a voltage spike until the failed portion of the network can be brought back on-line. Load shedding event 24 depicts an unanticipated reduction in demand. Before the supply can be reduced a significant increase in voltage occurs.

Grid designers have traditionally designed the level of supply to at least slightly exceed peak demand so that a “reserve” is available. The balancing of supply and demand may take place over a very large geographic area, such as the entire area of the eastern United States. Available electrical power has a negligible transmission delay. Thus, if a demand spike occurs in New York, electricity produced several states away may be used to match that demand.

Some difficulty has always existed, however, regarding the problem of a rapidly increasing demand. Power plants using heat-engines are not able to respond very quickly. They often require 60 minutes or more to bring idle production capacity on-line. Hydroelectric facilities may respond somewhat faster, assuming that suitable water levels are present. Some hydroelectric generators have the ability to respond in as little as 1 to 2 minutes. However, a response time of 5 to 10 minutes is more realistic.

Most generators used in heat-engine and hydroelectric facilities are synchronous AC generators that must be phase-matched before they can be safely connected to the grid. On older devices the phase-matching is at least in part a mechanical process and this takes some additional time. Thus, it is not simply a process of starting the prime mover and attaching an associated generator to the grid. The generator must be stabilized in speed and phase matched before it is connected. Thus, even if extra production capacity is present, it is often not possible to bring it online with sufficient speed.

In recent years regulatory authorities have explored the possibility of using “demand side” energy management to improve power quality. Demand side management gives the power producer (or sometimes a separate regulatory authority) the ability to impose limits on demand by selectively shutting down certain non-essential devices. As an example, most electrical grids reach a peak demand sometime in the early afternoon. A demand side management scheme could send a command that shuts down all electrical clothes driers during the period of peak demand. Demand side management seeks to improve power quality by smoothing out peaks and troughs on the demand side. These schemes have improved power quality in some areas, though they are often unpopular with consumers.

New challenges have emerged in recent years in the form of supply side instability. The challenge of managing an electrical grid has traditionally been matching a rapidly variable demand against an available supply that cannot be varied nearly so rapidly. The quality of the power on a grid is largely dependent upon achieving an adequate balance. A stable grid preferably features little variance in the voltage available and even less variance in the frequency of the alternating current. The “supply side” of this balancing problem was generally considered stable. The main challenge was being able to increase the available supply rapidly enough to accommodate the varying demand spikes.

Unfortunately, the stability of the supply side is no longer a given. In recent years, renewable energy is becoming an increasingly important piece of the global energy supply. The upswing in renewable sources obviously has many beneficial aspects. It is not without disadvantages, though.

The common approach to incorporating renewable energy sources in an existing grid is to adjust the conventional “base generation” available from conventional sources so that the total level of generation will be appropriate once the renewable sources are added. This approach works in theory, but it is often difficult to predict the amount of power that will be produced by renewable sources on any given day. Wind and solar energy are a major component of the renewable supply. These change significantly from day to day and even hour to hour.

Biogas-based energy production is a more stable form of renewable energy. However, a disadvantage of biogas-based energy is that is cannot be efficiently switched off during times when the power is not needed. A biogas plant uses “digesters” to convert base material into methane gas. The methane gas is then typically burned in a reciprocating engine to produce rotational energy. These plants are made efficient by matching the consumption rate of the engines to the production rate of the digesters. It is possible to turn the engine on and off as desired—representing a significant advantage over wind and solar—but this is not really practical.

The digesters use a steady-state process that produces methane gas whether the gas is being used or not. The process is slow to start and stabilize. It is best to run the digesters continuously and thereby produce methane continuously. It is possible to store methane but this is not an efficient option. Thus, if the methane engine is turned off it cannot be turned off for long. In addition, though it is certainly possible to cycle a reciprocating methane engine on and off, constant cycling drastically reduces engine life and overall efficiency. It is therefore better to operate a biogas plant in an even less flexible fashion that a steam-driven plant. A steam-driven plant might be operated for three days and shut down for three, whereas a biogas plant is more efficient if it is operated continuously. The same is true for geothermal sources of energy.

The use of a significant percentage of wind and solar power means that the amount of available supply will vary significantly throughout the day. Biogas-based power can help by providing additional power during the periods when other renewable sources are not producing. However, it is not presently possible to shut off the biogas power when the other sources are producing and there is a resulting oversupply. The use of all three renewable (solar, wind, and biogas) is therefore creating new stability problems.

A good example is the nation of Germany. Germany has heavily promoted the use of renewable energy. Photovoltaic solar cells and wind turbines are now scattered widely across the landscape. Public policy requires that the renewable sources be connected to the grid, which has produced significant instability in a grid that once prided itself on its stability.

Over and under supply of power—sometimes called positive supply and negative supply—are therefore well-recognized problems. Planners are often able to match a long-term trend over the course of a day. It is the short-term trend that causes difficulty. The demand and supply sides are now constantly changing and this becomes very difficult to manage.

One short-term solution has been proposed by Beacon Power, LLC, of Tyngsboro, Mass., U.S.A. Beacon uses a mechanical flywheel energy storage system. During periods of positive supply, the excess power is used to accelerate the flywheel. During periods of negative supply energy is extracted from the flywheel and returned to the grid. The flywheel-based solution can address very short-term fluctuations. It is not capable of handling medium to long-term fluctuations, however, because the flywheel on the one hand can only be accelerated up to its limiting speed and on the other hand can only store a limited amount of energy.

Battery-based storage systems are now being used with some wind farms as well. These can store and return power in a fairly short time period. Significant questions remain, however, regarding their cost and long-term performance. Thus, the problem of electrical distribution grid stability remains.

The grid stability problem can be broken down into three segments according to the duration of the energy imbalance one is seeking to address. These three segments are: (1) short term fluctuations of 0-5 seconds: (2) mid-term fluctuations of 5 seconds to 5 minutes; and (3) long-term fluctuations of 5 minutes to hours or even days. The long-term fluctuations are presently addressed by bringing the prime movers in conventional plants on line and off-line.

Very short term fluctuations can be handled by mechanical solutions such as the flywheel system. What is needed is a method to smooth supply fluctuations that is preferably applicable to all the environments.

The inventive method takes advantage of some relatively recent developments in power transmission technology. An understanding of these developments is significant to the reader's understanding of the invention and they will therefore be explained in some detail.

FIG. 1 shows a prior art system for generating three-phase AC power. 3-phase grid 20 includes three lines (L1, L2, and L3). Prime mover 10 provided rotational power. The objective of the device is to transform the rotational power of prime mover 10 into electrical power that can be placed on 3-phase grid 20.

This conversion has traditionally been performed by synchronizing the speed of a 3-phase AC generator attached to the prime mover. FIG. 1 shows a newer approach. 3-phase AC generator 12 produces three phases (with each phase being separated 120 degrees from its neighbor). Matching these phases to the electricity on the grid traditionally required a synchronous generator turning at the proper speed. In the system of FIG. 1, a synchronous generator is not necessary.

Instead, the three phases produced by the generator are fed into inverter 14. The inverter rectifies the AC power coming in and produces DC voltage. The DC voltage is placed on DC bus 16 as shown. DC bus 16 is connected to IGBT inverter module 18. The IGBT inverter module converts the available DC power into 3-phase AC power. It also phase-matches the AC power produced to the power existing on 3-phase grid 20. This phase-matched AC power is then fed onto the grid as shown.

FIG. 4 shows a simplified depiction of one embodiment of IGBT inverter module 18. While a full description of the operation of an IGBT or an IGBT-based inverter module is beyond the scope of this disclosure, some basic description may aid the reader's understanding.

“IGBT” stands for insulated gate bipolar transistor (some references state that it refers to an integrated gate bipolar transistor, but the use of the phrase “insulated gate” seems to be more widely accepted). As the name suggests, an IGBT is a bipolar device. It is either on or off. A low-power control voltage is used to switch the IGBT on and off. These devices are capable of switching high-power loads. A single IGBT may have a rating of 3,000 V and 200 A. The devices are often connected and switched in parallel. A multi-IGBT module may have a rating as high as 1,200 A.

In addition to their ability to switch high voltages and currents, IGBT's also have the ability to switch very rapidly. The switching function is now commonly placed under digital control. In the embodiment of FIG. 4, six IGBT's are present. Each phase of the desired 3-phase output includes two IGBT's. Each IGBT is switched by a control line 26.

The control lines are switched rapidly on and off by the digital controlling device. The result is that rapid pulses of the available DC voltage are placed on a selected phase. The result is shown in FIG. 5. Pulses of applied DC voltage 32 are applied in order to produce a sinusoidal (or approximately sinusoidal) single phase current 34.

IGBT inverter modules may include smoothing capacitors, filters, and other devices. However, since the grid itself is an inductive load, the grid itself may provide sufficient smoothing to convert the pulsed output of the IGBT module into the desired sinusoidal AC.

Those skilled in the art will know that IGBT inverters assume many forms. The example of FIG. 5 assumes a variable pulse width, with longer pulses being used to increase the single phase current. Some IGBT's use a constant pulse width and vary the pulse frequency to create the desired effect.

Whatever form the IGBT inverter module takes, the reader will understand that it can convert an available DC power source into phase-matched AC power. Further, the inverter module can very rapidly match the phase of the grid onto which it is feeding power. The phase-matching can occur in a matter of milliseconds. Thus, as long as a source of DC power is available, an IGBT inverter module allows that power to be rapidly connected to an existing AC grid, and rapidly disconnected from the AC grid. This functionality is significant to the present invention.

### BRIEF SUMMARY OF THE PRESENT INVENTION

The present invention comprises a method for improving grid power quality despite the presence of rapidly changing loads and a rapidly changing supply. The inventive method includes an energy generation mode that is used when grid demand exceeds grid supply and an energy storage mode that is used when grid supply exceeds grid demand. The method is able to rapidly switch between the two modes.

A power producing device such as a biogas engine or wind turbine produces electrical power. The electrical power is phase matched and placed onto the grid during times when additional power is needed. When no power is needed, the electrical power is switched instead to a load bank that converts the electrical power to heat. The heat is stored in a suitable thermal storage unit.

The energy storage unit provides energy to a heat engine such as an Organic Rankine Cycle engine (“ORC engine”) that uses the thermal storage unit as its heat source. The ORC engine includes a turbine driving a generator (“ORC generator”). When additional power is needed on the grid, the ORC generator is phase matched and applied to the grid. This operation “retrieves” some of the energy that was previously stored in the thermal storage unit.

When no power is needed on the grid, the ORC generator is switched to the load bank. It would of course be more efficient to simply shut down the ORC engine, rather than dumping its output back into the heat source that is used to power its evaporator. However, an objective of the present invention is to allow rapid switching between the energy production and storage modes. A cycle time of only a few seconds is preferable and even faster cycle times are more preferable. It is therefore desirable to keep the ORC engine running even when the electrical power it produces is not applied to the grid. This allows the turbine within the Organic Rankine Cycle engine to remain “spooled up” and ready to produce power as it is needed.

### BRIEF DESCRIPTION OF THE SEVERAL VIEWS OF THE DRAWINGS

FIG. 1 is a schematic view, showing a prior art system for converting mechanical energy to 3-phase electrical energy that is placed on an existing power grid.

FIG. 2 is a plot of single phase grid voltage over time.

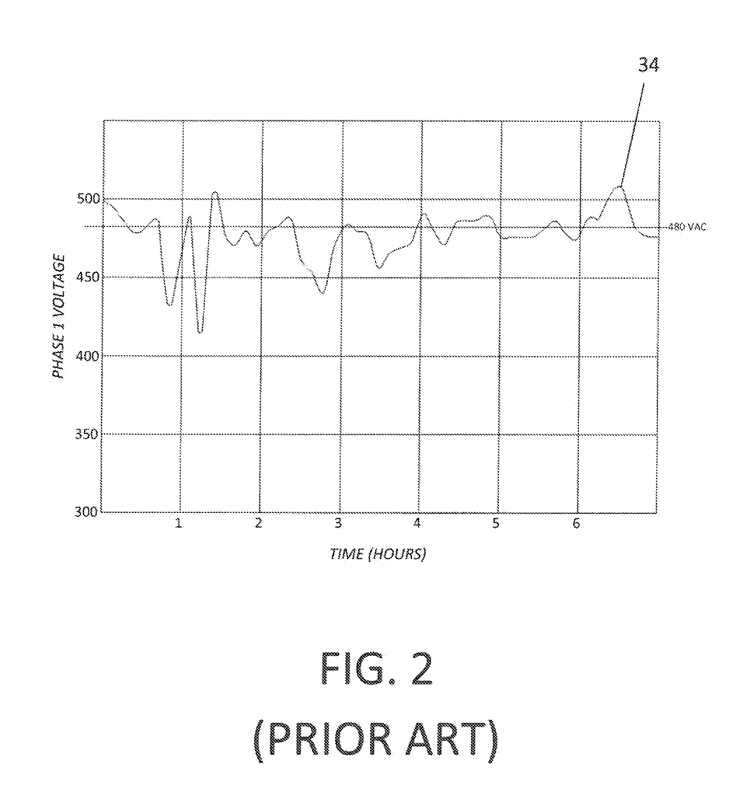

FIG. 3 is a plot of single phase grid voltage as various load events occur.

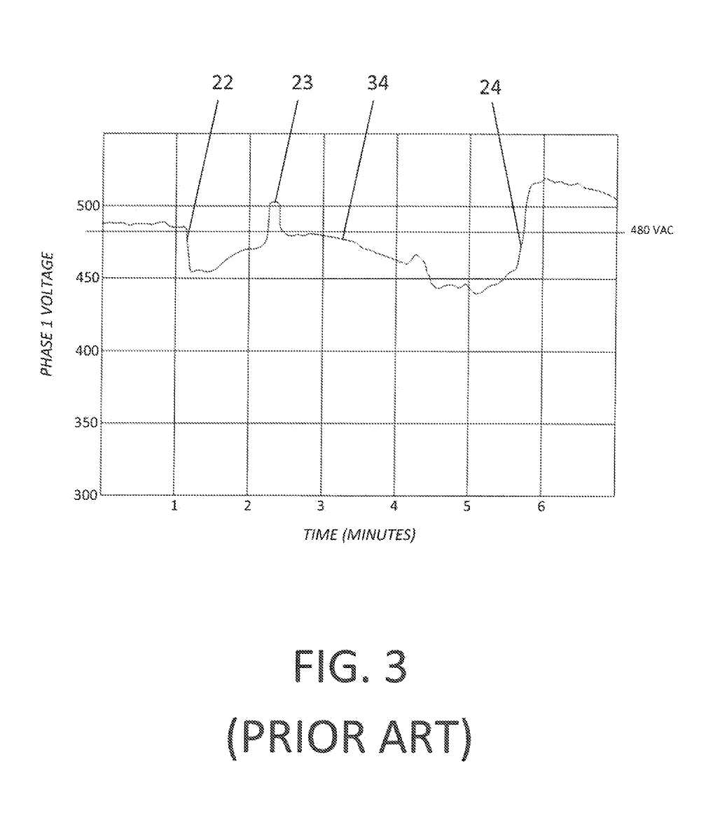

FIG. 4 is a schematic view, showing a prior art IGBT inverter module.

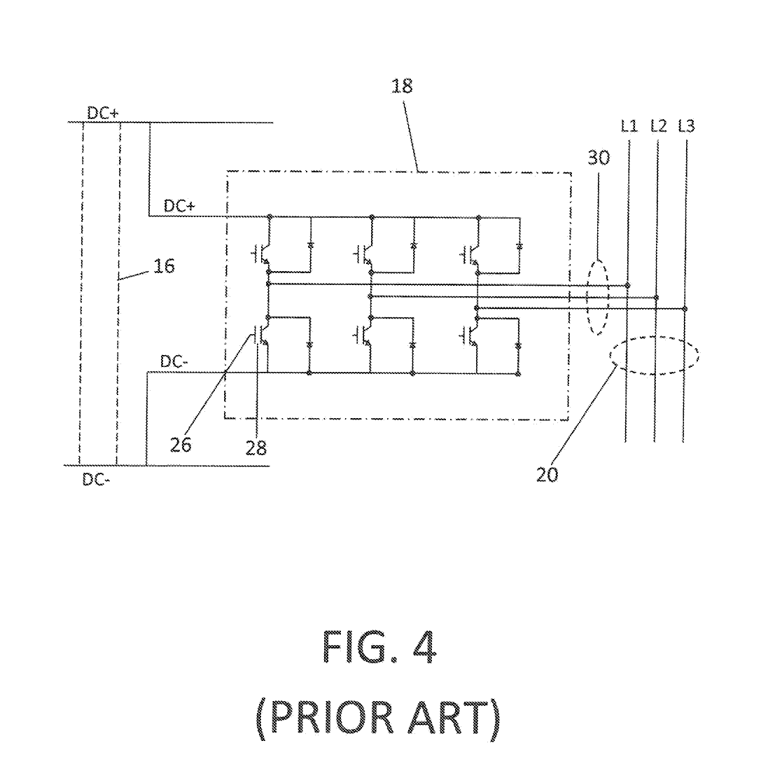

FIG. 5 is a plot of the sinusoidal line current produced by an IGBT inverter module.

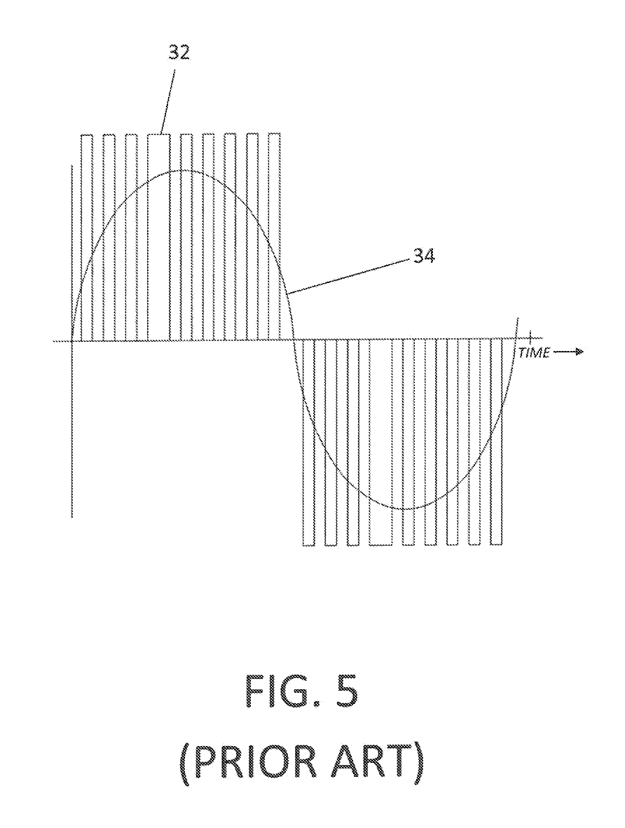

FIG. 6 is a schematic view, showing the present invention.

FIG. 7 is a schematic view, showing the present invention when operating in the energy storage mode.

FIG. 8 is a schematic view, showing the present invention when operating in the energy generation mode.

FIG. 9 is a plot of single phase grid voltage showing the operation of the present invention.

FIG. 10 is a schematic view, showing the operation of the present invention using wind and solar power inputs.

FIG. 11 is a schematic view, showing an embodiment in which a DC generator is used to selectively power a load bank and a phase-matched inverter.

FIG. 12 is a schematic view, showing an embodiment of the present invention in which a a biogas engine and an ORC engine each have a separate thermal storage unit.

FIG. 13 is a schematic view, showing an embodiment of the present invention in which a biogas engine and an ORC engine share a common thermal storage unit.

FIG. 14 is a schematic view, showing an embodiment in which a biogas engine employs a synchronous 3-phase generator that may be selectively connected directly to the power grid.

FIG. 15 is a schematic view, showing an embodiment in which a biogas engine and an ORC engine both feed onto a common DC bus.

### REFERENCE NUMERALS IN THE DRAWINGS

| | | | |
|---|---|---|---|
| 10 | prime mover | 12 | 3-phase generator |
| 14 | inverter | 16 | DC bus |
| 18 | IGBT inverter | 20 | 3-phase grid |
| 22 | loading event | 23 | transient event |
| 24 | load shedding event | 26 | control line |
| 28 | IGBT | 30 | 3-phase output |
| 32 | applied DC voltage | 34 | single phase voltage |
| 36 | biogas engine | 38 | IGBT shunting module |
| 40 | exhaust | 42 | exhaust heat exchanger |
| 44 | thermal storage unit | 46 | load bank |
| 48 | pump | 50 | ORC engine |
| 52 | evaporator | 54 | preheater |
| 56 | pump | 58 | condenser |
| 60 | turbine | 62 | 3-phase generator |
| 64 | rectifier | 66 | IGBT shunting module |
| 68 | IGBT inverter module | 70 | 3-phase output |
| 72 | ORC circulation loop | 73 | DC output |
| 74 | heat transfer loop | 76 | power management system |
| 77 | mode of operation | 78 | wind power |
| 80 | solar power | 82 | DC bus |
| 84 | DC generator | 86 | Phase 1 IGBT module |
| 88 | Phase 2 IGBT module | 90 | Phase 3 IGBT module |
| 92 | IGBT chopper | 94 | storage tank |
| 96 | ORC circulation lines | | |

### DETAILED DESCRIPTION OF THE INVENTION

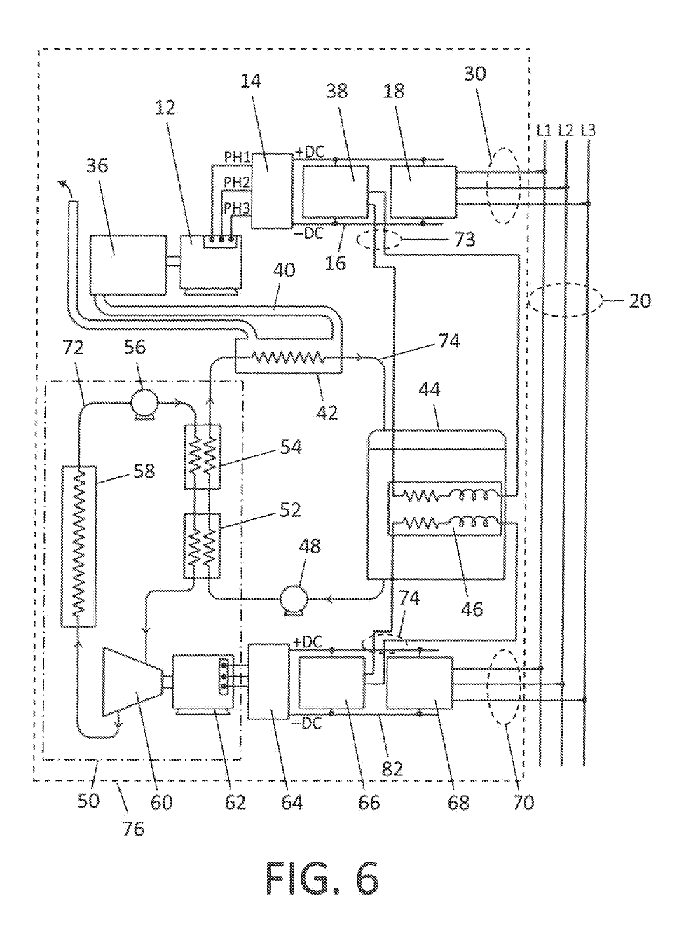

FIG. 6 shows the components of the present invention. Subsequent figures clarify the two anticipated modes in which the invention is operated. In FIG. 6, power management system 76 is connected to a larger 3-phase grid 20. The 3-phase grid may be any power distribution grid ranging in size from a local power station feeding a surrounding area to a national or international network.

Power is separately supplied to 3-phase grid 20 by conventional power sources and possibly renewable sources as well. Power management system 76 may include everything in FIG. 6 except the 3-phase grid it is connected to (lines L1, L2, and L3). The invention is connected to at least one power generating device, which may assume many different forms. In the embodiment of FIG. 6, the power generating device is biogas engine 36.

As explained previously, a biogas engine is connected to a source of biogas—which is typically a biogas “digester.” The digester converts biomass into methane gas and this methane gas is burned in the combustion process within the biogas engine. Such engines are typically reciprocating engines. Biogas engine 36 has a rotating output shaft. This output shaft drives 3-phase AC generator 12.

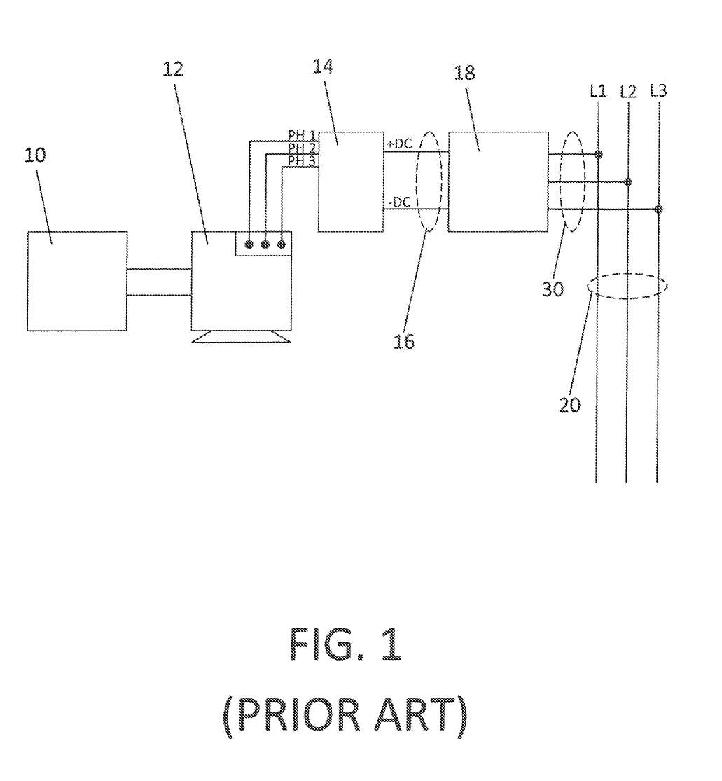

The AC generator feeds into rectifier 14. The rectifier feeds DC power onto a DC bus. IGBT inverter module 18 generates a phase-matched AC waveform that is fed onto 3-phase grid 20 in the same manner as the prior art device shown in FIG. 1. IGBT shunting module 38 is added, however. This device is capable of diverting the DC power on DC bus 16 to a separate energy storage device. In the embodiment of FIG. 6, the energy storage device is thermal storage unit 44.

The thermal storage unit may be a tank containing a volume of fluid suitable for the storage of energy in the form of heat. Examples include mineral oil formulations used to cool transformers.

As explained previously, it is preferable to run biogas engine 36 continuously. Existing 3-phase grid 20 will cycle between periods of oversupply and periods of undersupply. During periods where the 3-phase grid can readily accept the output of biogas engine 36, IGBT inverter module 18 is active and IGBT shunting module 38 is inactive. In these periods the IGBT inverter module performs its conventional operation of driving the voltage and phase of its 3-phase output 30 to appropriate values so that the generated power may be safely fed onto 3-phase grid 20. This is referred to as the “energy generation mode.”

During periods where the 3-phase grid has an oversupply and cannot readily accept the output of biogas engine 36, IGBT inverter module 18 becomes inactive and IGBT shunting module 38 becomes active. The IGBT shunting module diverts the power produced by biogas engine 36 to load bank 46 associated with thermal storage unit 44. In the embodiment shown, the load bank is a group of resistance heaters that is used to raise the temperature of the liquid within thermal storage unit 44.

The load bank may simply be a cluster of resistance heaters immersed in a suitable dielectric oil (such as transformer oil). In other instances the oil may be circulated through the load bank and stored in a separate, insulated container. The electrical energy supplied to load bank 46 heats the liquid contained within thermal storage unit 44. This operation is referred to as the “energy storage mode.”

It is of course desirable to recover the energy stored in thermal storage unit 44 at a later time when it can be used. An organic Rankine cycle engine (“ORC engine”) is provided for this purpose. An ORC engine is a heat engine using a specialized working fluid (as compared to a conventional working fluid like steam). The specialized working fluid within an ORC engine allows such engines to extract energy from relatively low-temperature heat sources, such as the exhaust of an internal combustion engine.

A discussion of the details of ORC engines it beyond the scope of this disclosure. The reader wishing to know more detail about such devices is referred to U.S. Publication No. 2009/0277400, which discloses an ORC engine devised by the present inventor. A typical working fluid for an ORC engine has a relatively low boiling point. As an example. Genetron 245fa (1,1,1,3,3-pentafluoropropane) has a boiling point of only 15.3 degrees Celsius (60 degrees Fahrenheit).

ORC engine 50 recovers thermal energy stored in thermal storage unit 44 and converts it to electrical energy. In the embodiment of FIG. 6, waste heat from the combustion exhaust of biogas engine 36 is also available. ORC engine 50 is preferably equipped to utilize the waste exhaust heat also.

Heat transfer loop 74 is provided to transfer thermal energy from the available sources to ORC engine 50. Pump 48 drives the circulation within this loop. A suitable working fluid is pumped from thermal storage unit 44, through pump 48, evaporator 52, preheater 54, exhaust heat exchanger 42, and back to thermal storage unit 44.

ORC circulation loop 72 is provided to transfer the ORC working fluid within ORC engine 50 itself. Pump 56 circulates the ORC working fluid through preheater 54, evaporator 52, turbine 60, and condenser 58.

The operation of the ORC engine itself will now be briefly explained. Pump 56 takes in liquid working fluid exiting the condenser and pressurizes it. The ORC working fluid next passes through preheater 54, which raises the temperature of the fluid but does not boil it. The fluid next enters evaporator 52 where the additional heat added causes it to transition to a pressurized vapor (The evaporator may alternatively be referred to as a “boiler”).

The pressurized vapor is then expanded through turbine 60. The expanded vapor is then cooled by passing through condenser 58, which converts it back to a liquid. Turbine 60 includes a rotating output shaft that provides mechanical power to 3-phase generator 62.

3-phase generator 62 feeds power into rectifier 64. Generator 62 may be referred to as the “ORC generator” to distinguish it from generator 12. Rectifier 64 supplies DC power to DC bus 82. A second set of IGBT shunting and inverter modules are connected to DC bus 82. These are IGBT shunting module 66 and IGBT inverter module 68.

IGBT inverter module 68 selectively applies voltage and phase-matched 3-phase output 70 to 3-phase grid 20. IGBT shunting module 66 selectively applies the output of rectifier 64 to thermal storage unit 44.

The reader will thereby appreciate that: (1) the output of biogas engine 36 is selectively applied to 3-phase grid 20 or to thermal storage unit 44; and (2) the output of ORC engine 50 is selectively applied to 3-phase grid 20 or to thermal storage unit 44. The ability to quickly switch the output of the power generation sources is important to the present invention. As explained previously, the IGBT modules are capable of switching on and off in a matter of 1 or 2 milliseconds.

The invention typically operates in one of two distinct modes (though other modes are also encompassed). These are referred to as the energy storage mode and the energy generation mode. The invention is capable of switching between these two modes in a matter of milliseconds. As an example, the invention might be operating in the energy storage mode for one second, followed by 0.5 seconds of operation in the energy generation mode, followed by a resumption of the energy storage mode.

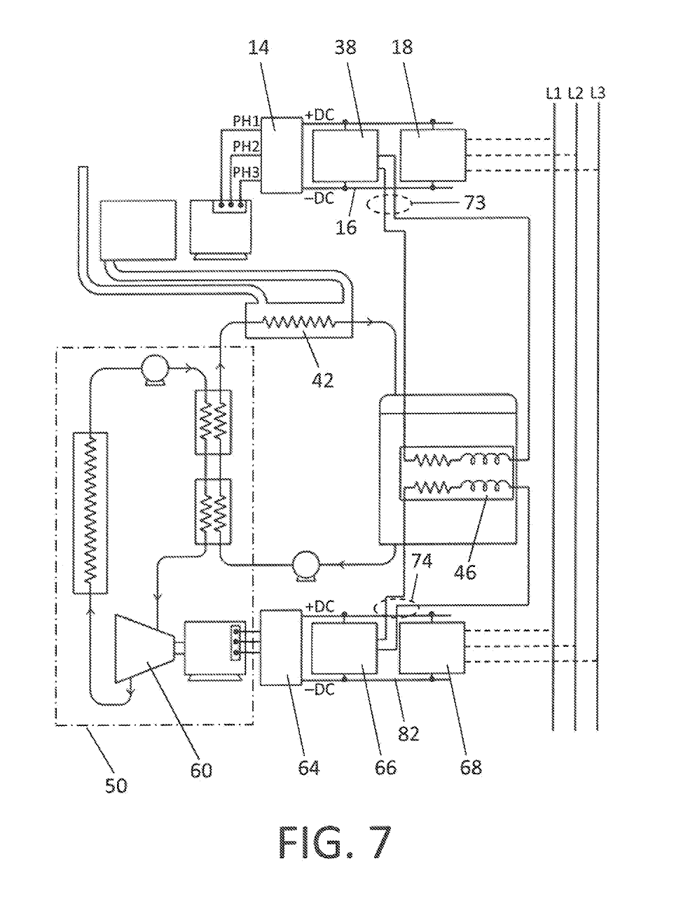

FIG. 7 graphically illustrates the operation of the invention in the energy storage mode. This mode of operation will typically be used when there is an oversupply of power on 3-phase grid 20. In such a situation, supplying additional power to the grid would only worsen an undesired situation. IGBT inverter module 18 is switched off so that power from 3-phase generator 12 is no longer delivered to the grid. IGBT shunting module 38 is activated to apply DC output 72 to load bank 46. Thus, the power produced by biogas engine 36 is diverted from the 3-phase grid into thermal storage unit 44.

The reader will recall that biogas engine 36 is preferably operated continuously. It is also preferable to operate ORC engine 50 continuously. The ORC engine may operate at differing flow rates and power output, but it is undesirable to shut it down entirely. This is true in part because exhaust heat exchanger 42 is always receiving thermal energy from exhaust 40 of the biogas engine. Thus, some thermal input it always present. Running the ORC engine continuously also facilitates the desired rapid switching between storage and generation modes.

Since the ORC engine runs continuously, turbine 60 will be turning and there will be some electrical power being fed from 3-phase generator 62 to rectifier 64 and onto the associated DC bus 82. IGBT inverter 68 is turned off so that the power produced by 3-phase generator 62 is not fed onto the grid. Instead, IGBT shunting module 66 is activated in order to feed the available DC output 74 to load bank 46.

The power diverted via IGBT shunting module 66 is thereby being used to add energy to the thermal storage unit, which is in fact being used as one of the two energy sources for the ORC engine. This connection may be reminiscent of a perpetual motion scheme, in that the output of the ORC engine is being fed back into the same energy source that is being used to power the ORC engine. This is not the case for several reasons. First, the reader should bear in mind that the energy storage mode is only operating for part of the time. Second, the ORC engine receives considerable energy from the exhaust heat of the biogas engine, so it is not just depending on receiving energy from the thermal storage unit.

Third, while running the ORC engine to “bank” energy back in the thermal storage unit is indeed inefficient, overall efficiency is not the primary objective of the present invention. The primary objective of the invention is ameliorating power oversupply and undersupply conditions existing on the 3-phase grid. It is more important to keep the ORC engine in a running state than to achieve maximum efficiency, since the running state is desirable for rapid switching between modes.

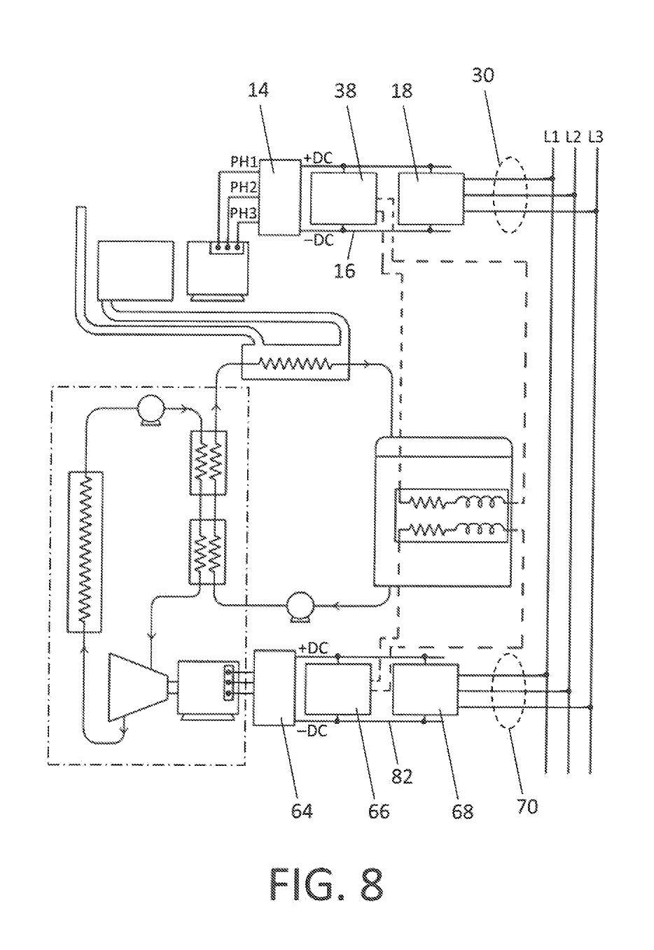

FIG. 8 graphically illustrates the operation of the invention in the energy generation mode. This mode of operation will typically be used when there is an undersupply of power on 3-phase grid 20. In such a situation, additional power is needed. The two IGBT shunt modules (38, 66) are shut down and the two IGBT inverter modules (18, 68) are activated. In this configuration, the output of 3-phase generator 12 and 3-phase generator 62 are both connected to the grid (with appropriate voltage and phase matching).

During the energy generation mode, energy that was previously stored in thermal storage unit 44 is recovered via the ORC engine using some of that heat to drive 3-phase generator 62. Electricity produced by this generator is fed onto the grid using IGBT inverter module 68. As discussed previously, the storage and recovery process will not be terribly efficient. In fact, the efficiency of “banking” the unwanted power production in the thermal storage unit and recovering it using the ORC engine and the associated electrical devices may only be 5-15%. Again, however, the primary objective of the invention is improving the quality of the power on the grid. If any of the stored energy is recovered, this is properly considered a desirable secondary objective.

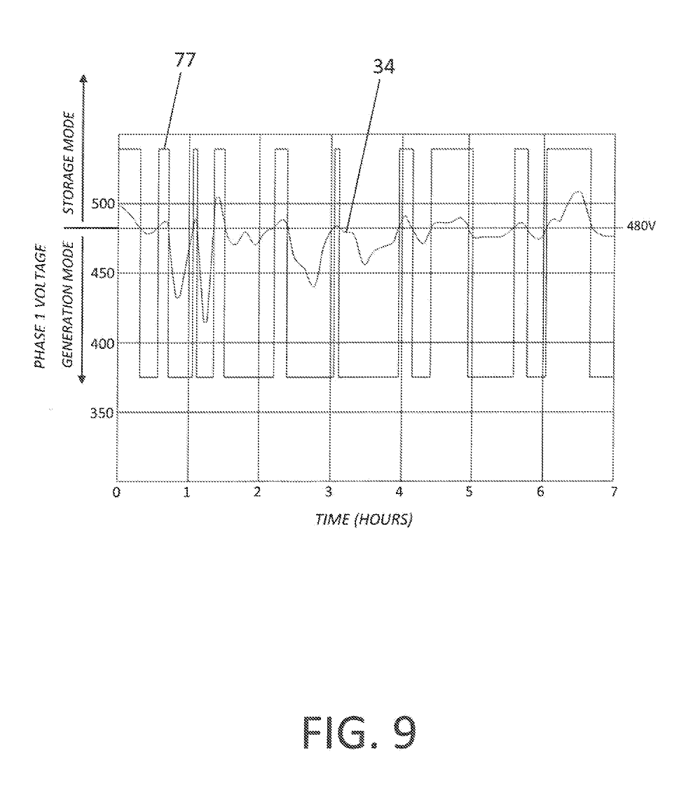

FIG. 9 shows a plot of grid voltage over time. The reader will observe how single phase voltage 34 deviates off the desired value of 480 volts. The plot also shows mode of operation 77 for a single unit of the present invention (such as the embodiment of FIG. 6). When grid voltage is 480 V or higher, the invention goes into energy storage mode. When grid voltage falls below 480 V, the invention goes into energy generation mode.

Switching between modes can occur at various intervals. The reader will note that the invention may remain in one mode for hours or even days. On the other hand, the invention may switch for intervals as short as a few milliseconds.

A biogas engine in a single instance of the present invention may provide 1 to 5 MW of usable electricity. For a large grid, the application or removal of 5 MW will not alter the grid power quality significantly. A very simple “mode control” system may be used for such an installation. On its simplest level, the control system simply monitors grid voltage and changes mode according to whether the grid voltage is above or below a defined value.

Of course, it is preferable to provide many different instances of the present invention attached to a common grid. Once a significant percentage of the power supplied to the grid passes through a system such as power management system 76, the switching of the modes will significantly improve grid stability. With enough systems on line, the grid voltage may be smoothed considerably. Those skilled in the art will realize that the simple control technique of switching between modes according to instantaneous grid voltage may not work well for a more complex installation. Unwanted coupling phenomena can occur and these may even drive the grid voltage into cyclic variations. In such a situation it is preferable to provide a more sophisticated control regime, with multiple examples of power management system 76 possibly being regulated by a single master control system.

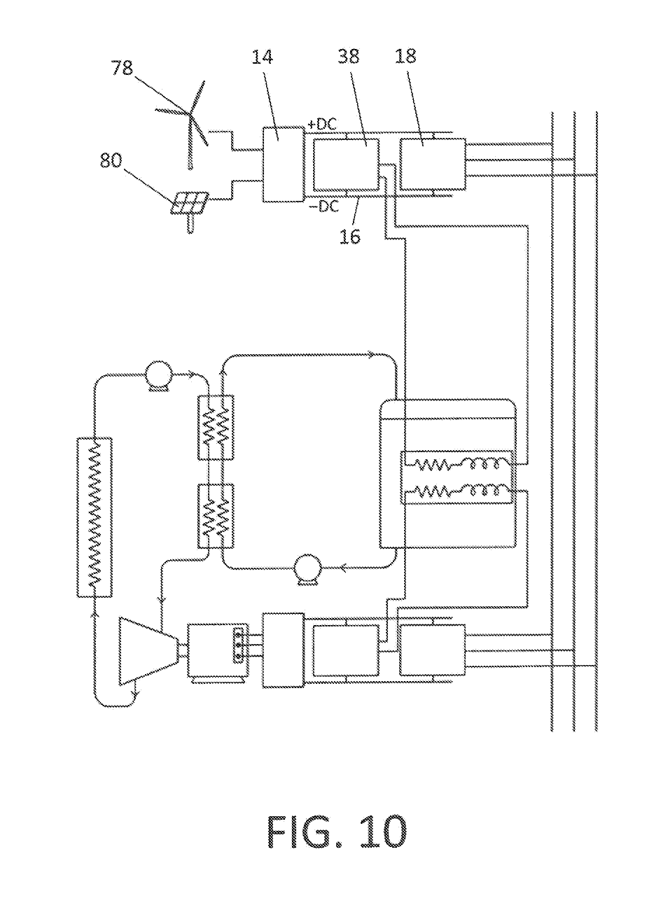

FIG. 10 shows an alternate embodiment in which the energy source being fed into the system is not a biogas engine. In this embodiment wind power 78 and solar power 80 are both being fed into the grid. Both these energy sources are difficult to predict. Wind power output may increase dramatically in the mid afternoon, for example. Solar power may plummet when an unexpected cloud layer blankets a collecting array.

The embodiment of FIG. 10 ably illustrates why power grid managers are reluctant to have power sources such as wind and solar directly connected to the grid. A grid manager traditionally has little control over the addition or subtraction of energy from these sources. This is in contrast to the legacy steam-driven power plants where the grid manager has precise control (albeit with an undesirably long latency).

If power sources such as shown in FIG. 10 are connected to the grid through power management system 76, the concern over unwanted power variations is eliminated. If the production from wind and/or solar power increases at a time when more grid power is not needed, the invention will switch into the energy storage mode rather than placing the unwanted power on the grid. On the other hand, if the wind and/or solar power increases at a time when demand on the grid is high, the grid manager will welcome the operation of the invention in the energy generation mode.

It is not necessary to connect each individual wind turbine or solar array to an individual power management system 76. Those skilled in the art will know that clusters of devices may be fed into a single power management system 76. A cluster of dissimilar generating devices (such as a mixture of some wind turbines and some solar arrays) could even be fed into a single power management system.

Looking again at FIG. 6, the reader will recall that in this embodiment a single power source feeds electrical power through rectifier 14 and onto the DC bus 16 feeding IGBT inverter module 18 and IGBT shunting module 38. It is also possible to have multiple rectifiers feeding power onto the DC bus. A first rectifier could receive power from a biogas engine, a second could receive power from a photovoltaic array, and a third could receive power from a wind turbine.

The embodiment shown in FIG. 6 could be modified in many ways while still carrying out the inventive process. As one example, one could configure the power management system so that the ORC engine simply shuts down when the system goes into the energy storage mode. This option will work if the system does not remain in the energy storage mode for too long. It is not the preferred embodiment, because running the ORC continuously allows the system to switch rapidly back and forth between the storage and generation modes, but it can be operated this way. As a second example, exhaust heat exchanger 42 could transfer heat directly to ORC circulation loop 72 rather than to heat transfer loop 74.

The two IGBT shunting modules are shown as switching the DC power on the two DC buses directly to load bank 46. The IGBT shunting modules could transfer the electrical power in another form—such as 3-phase AC power. This would require a somewhat more sophisticated shunting module with three output lines instead of two, but the operation of the system as a whole would not be materially different.

It is also possible to employ the device to feed power to a DC grid rather than a 3-phase AC grid. In that case the IGBT inverter modules would assume a different form, but again the basic principles under which the invention operates would be the same.

Thermal storage unit 44 in FIG. 6 is properly viewed as one example of an energy storage device that can be used in the invention. The use of a heated oil is preferred since this technology is mature. However, one can envision many different storage media. It is even possible to store heat in solid materials such as a large volume of cast concrete.

As mentioned previously, it is preferable to run the ORC engine continuously. This approach favors the use of a variable-speed turbine, since the temperature difference between the evaporator and the condenser in ORC circulation loop 72 will vary according to the temperature of thermal storage unit 44.

Conventional heat engine power plants use a turbine running at a regulated, continuous speed. This is a requirement of a synchronous generator. However, the reader should recall that the present invention does not require a synchronous generator. The present invention uses IGBT-based devices to convert a variable speed input to a desired output voltage. The speed of the input mechanical device of course determines the amount of available power, but this tends only to vary the amount of electrical current available, and not the voltage or desired waveform.

Those skilled in the art will realize that the IGBT inverter module and IGBT shunting module could be combined into a single device. One could even place an individual shunting IGBT on each phase output line of the IGBT inverter module itself, with these shunting IGBT's switching the 3-phase output between 3-phase grid 20 and load bank 46.

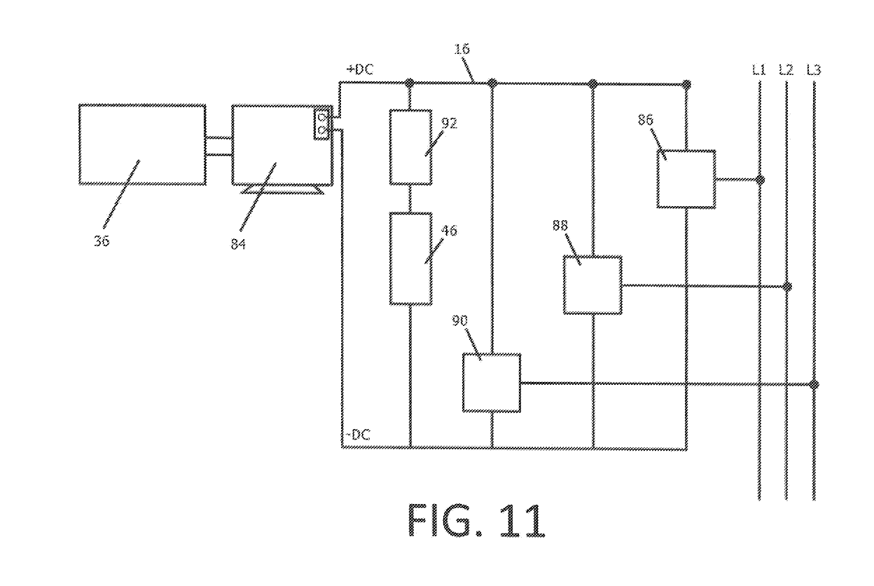

Those skilled in the art will also realize that many more variations are possible using known components. FIGS. 11-15 illustrate a few of these additional variations. FIG. 11 shows biogas engine 36 powering DC generator 84. In this version DC power is created via the rotating machinery itself (as opposed to converting 1 or 3 phase AC to DC). DC generator 84 fees direct current onto DC bus 16 (which includes a positive rail and a negative rail).

As for the prior embodiments, DC power available on DC bus 16 is selectively switched to an existing grid (L1, L2, L3) or to a load bank 46 (heating element(s) used to heat a thermal storage medium). Each output phase has its own IGBT switching module. These are PH1 IGBT module 86, PH2 IGBT module 88, and PH3 IGBT module 90. Each IGBT module may include a pair of IGBT's. An IGBT pair is used to selectively place positive or negative DC current pulses onto the phase it feeds, in order to match the alternating current found on the grid (positive pulses being used during the positive half of the AC wave and negative pulses being used during the negative half of the AC wave).

In addition to the IGBT output modules, IGBT chopper 92 selectively connects load bank 46 across the two rails of the DC bus. In the energy generation mode, IGBT chopper 92 is “open”—meaning that no current flows through load bank 46. IGBT's within the three TGBT output modules 86, 88, 90 are selectively switched on in order to generate pulse trains that are suitable for adding to the three-phase grid power (being matched in phase).

In the energy storage mode, all the IGBT's within the three IGBT output modules 86, 88, 90 are switched off. IGBT chopper 92 is switched on. Thus, all the power available on DC bus 16 is fed through load bank 46 in order to heat a thermal storage medium.

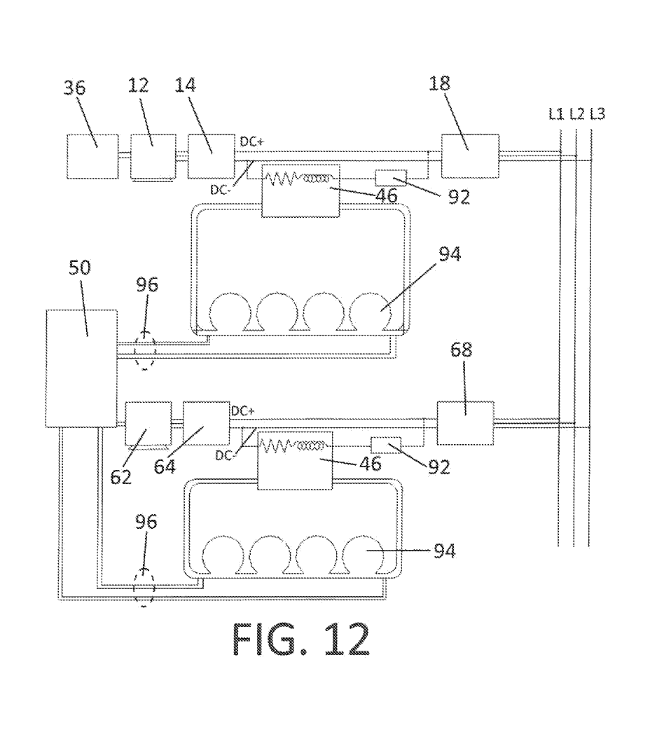

FIG. 12 shows another embodiment incorporating biogas engine 36 and ORC engine 50. The ORC engine may be any suitable Organic Rankine Cycle Engine, such as the one illustrated in FIG. 6 or some other type. Biogas engine 36 provides rotational power to 3-phase generator 12. Inverter/rectifier 14 converts the incoming 3-phase AC power into DC. This DC power is then fed into IGBT inverter module 18. In addition, IGBT chopper 92 and load bank 46 are connected between the positive and negative DC rails coming from inverter 14. In the energy generation mode, IGBT chopper 92 is switched off and the IGBT's within IGBT inverter module 18 are switched in the appropriate sequence to phase match the pulses fed onto the grid L1, L2, L3.

In the energy storage mode, IGBT inverter module passes no power and IGBT chopper 92 is switched on so that the power available on the DC bus passes through load bank 46. The electrical energy passing through the load bank is converted to thermal energy and used to heat a circulating working fluid (such as thermal oil). This working fluid is stored within storage tanks 94. Suitable insulation is preferably provided.

ORC engine 50 is likewise connected to 3-phase generator 62. Inverter/rectifier 64 converts the 3-phase power produced by 3-phase generator 62 into DC power and places it on a second DC bus as shown. This second DC bus feeds power to IGBT inverter module 68, which is connected to the grid L1, L2, L3. A second IGBT chopper 92 and load bank 46 is selectively connected to this second DC bus. A second set of storage tanks 94 is associated with ORC engine 50 as shown.

The heated thermal storage working fluid is selectively circulated to ORC engine 50 via ORC circulating lines 96. The reader will note that a et of circulating lines connects the ORC engine to each of the two sets of storage tanks. A circulating pump and associated valves will likely be needed as well. These have been omitted from the views for purposes of visual clarity.

In the energy generation mode, heated thermal working fluid is sent from one or both sets of storage tanks through ORC engine 50. The turbine (expander) within the ORC engine spins 3-phase generator 62. Inverter/rectifier 64 converts the 3-phase AC power coming out of the generator to DC power and places it on a bus as shown. This bus feeds IGBT inverter module 68, which phases-matches the power and feeds it onto the grid L1, L2, L3. The IGBT chopper 92 associated with inverter 64 is open.

In the energy storage mode, the IGBT's within IGBT inverter module 68 are switched off. The IGBT chopper 92 in the lower circuit (from the vantage point of FIG. 12) is switched on and this feeds DC power through the lower load bank, thereby heating circulating working fluid within the lower storage tanks 94.

It is also possible to run the configuration of FIG. 12 in a “hybrid” mode where a portion of the output of inverter 14 is fed onto the grid (L1, L2, L3) while a portion is also passed through load bank 46 and used to heat the working fluid.

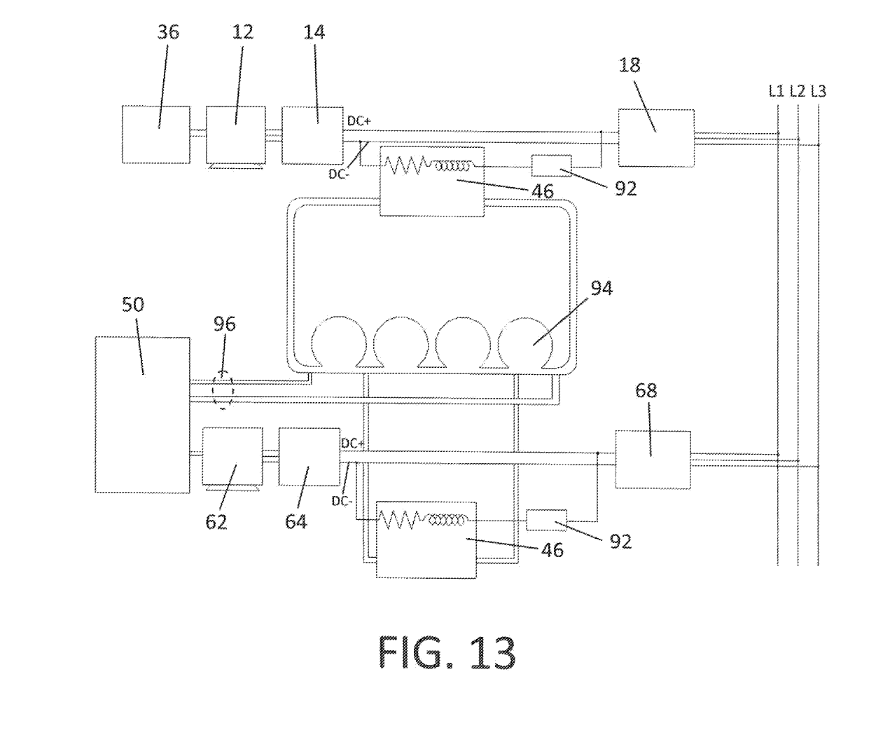

FIG. 13 shows a variation of the system of FIG. 12. In this version, a common set of storage tanks 94 is used for the biogas engine 36 and ORC engine 50. However, the biogas engine and ORC engine each has its own independently switched load bank 46. The two load banks are connected to the storage tanks via plumbing with suitable pumps and valves. It is typical to switch both IGBT choppers 92 at the same time. Thus, it is typical to energize the two load banks 46 at the same time and de-energize them at the same time. Working fluid is circulated through both load banks in order to heat the working fluid when the system is in energy storage mode.

ORC circulating lines 96 lead from storage tanks 94 to ORC engine 50. These transfer thermal energy from the storage tanks to ORC engine 50 when the system is in the energy generation mode. Of course, it is possible to connect one system—such as the ORC engine—to the grid while keeping the other system in energy storage mode.

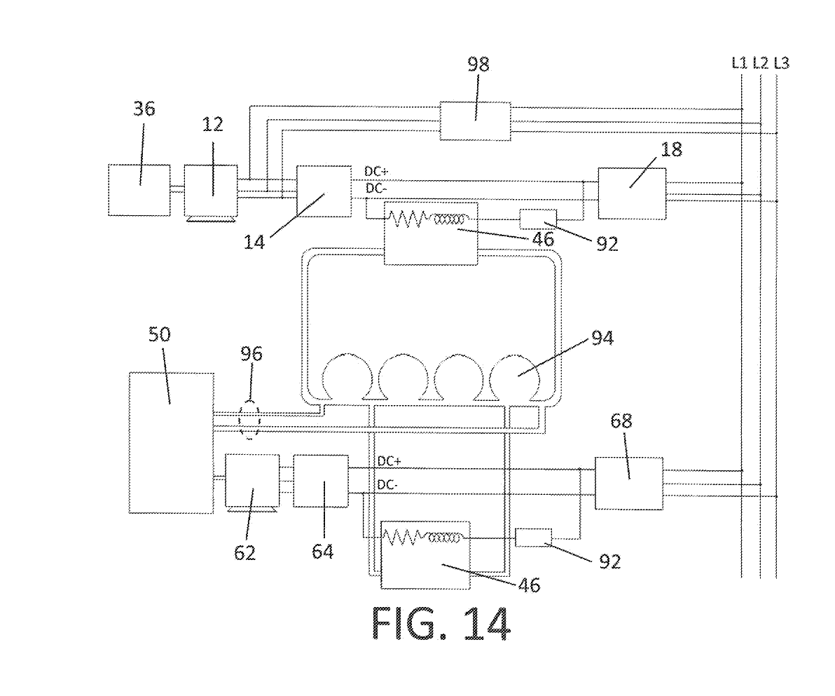

FIG. 14 illustrates yet another embodiment of the present invention. It incorporates the ability to connect one of the 3-phase generators directly to the electrical grid. As explained previously, it is often advantageous to use a non-synchronous generator that is then amplitude and phase-matched to the grid using active devices such as IGBT's. However, the reader will also recall that it may be desirable to operate some power-producing devices (such as biogas engine 36) in a steady state. It is certainly possible to amplitude and phase-match such a device to the AC power on the electrical grid and then run it in a synchronous mode.

As is known by those skilled in the art, the prime mover (such as a biogas engine) may be carefully regulated so that its speed remains constant and its phase remains constant. The field excitation characteristics of 3-phase generator 12 are then controlled to adjust the load torque imposed by the 3-phase generator. Once synchronous operation is established, the most efficient way to feed power from 3-phase generator 12 onto the electrical grid is a direct connection.

Shunting module 98 is provided to selectively create a direct connection between 3-phase generator 12 and the electrical grid. The shunting module may assume a wide variety of forms. It may simply be a set of three IGBT's—one for each phase. Electromechanical switches may also be employed. Any device that can selectively connect the generator to the grid will suffice.

The balance of the system shown in FIG. 14 is the same as the embodiment shown in FIG. 13. Note that a shunting module can be provided for connecting 3-phase generator 62 directly to the grid as well.

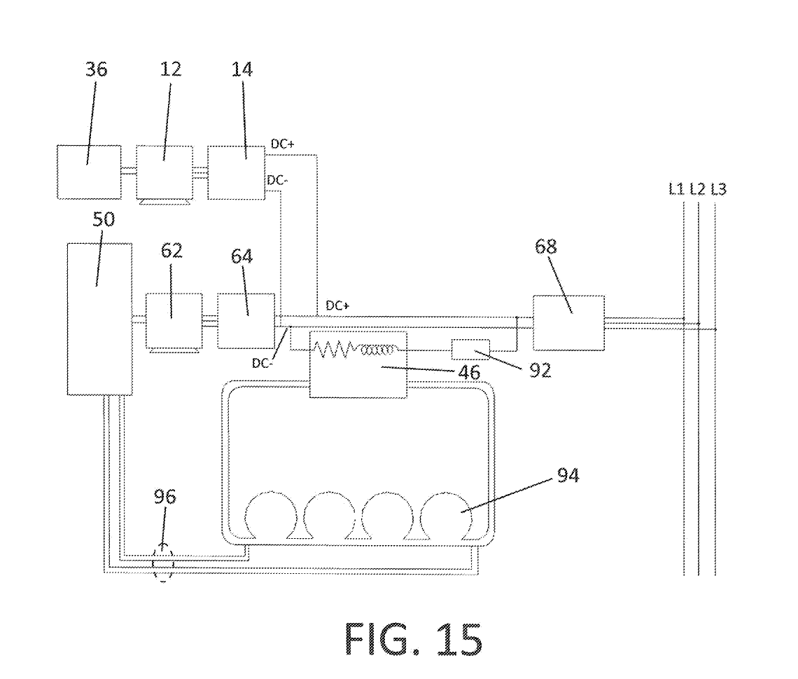

Those knowledgeable in the field of power generation and management will realize that many more variations are possible within the scope of the present invention. FIG. 15 shows an additional variation. Depending on current limitations and other factors it may sometimes be desirable to provide a single load bank 46 and a single DC bus. In the embodiment of FIG. 15, biogas engine 36 and ORC engine 50 ultimately feed a single DC bus. Biogas engine 36 feeds the bus through 3-phase generator 12 and inverter/rectifier 14. ORC engine 50 feeds the bus through 3-phase generator 62 and inverter/rectifier 64.

The common DC bus is connected to IGBT inverter module 68 and load bank 46. In the energy generation mode, the IGBT's within IGBT inverter module 68 are switched in order to create appropriate pulse trains to feed into the AC power on the grid. Thermal energy is fed from storage tanks 94 to ORC engine 50 via ORC circulation lines 96.

In the energy storage mode, IGBT inverter module 68 passes no current and IGBT chopper 92 is switched on so that current flows through load bank 46. In this mode the output of biogas engine 36 is converted to thermal energy and stored in storage tanks 94.

The reader's understanding may benefit from some discussion of ancillary components needed for the invention. Returning to FIG. 14, the reader will observe that both load banks 46 heat working fluid stored in a single set of storage tanks 94. Biogas engine 36 and ORC engine 50 may be located in close proximity. However, it is also possible that they will be separated some distance apart, and perhaps housed in separate buildings. Thus, the circulation piping between each load cell and storage tanks 94 is preferably well-insulated to avoid heat loss while the working fluid is in transit.

Depending on the voltages involved and the ambient temperatures, it may be desirable to locate the load banks in or next to the storage tanks themselves. In that case the distance between the prime movers and the storage tank would be covered by electrical cables rather than piping carrying the thermal storage fluid.

The storage tanks themselves preferably hold the heat for hours and even more preferably days. It is desirable to provide good insulation. In some conditions the tanks may be buried to further minimize heat loss. Control valves, piping, and pumps will be needed for some of the embodiments. These devices regulate the flow of the thermal storage fluid from the storage tanks to/from the load bank(s), and to/from the ORC engine.

While it is impossible to list and describe every variation that could be employed in the present invention, the following list provides some insight into the scope of the invention:

1. Resistance heaters in the load bank could be powered directly by 3-phase AC rather than DC electricity.

2. Rectification and phase-matching devices other than IGBT's may be used.

3. Each load bank may simply be an immersed resistance coil.

4. Some installations may include multiple biogas engines and multiple Organic Rankine Cycle engines.

5. The invention is not limited to any particular kind of heat engine, such as an ORC.

6. The invention is not limited to any particular source of electrical power. The invention is obviously suitable for use with biogas engines, wind turbines, and solar cells, but could also be applied to any type of prime mover.

7. The invention might not include a DC bus at all, but could instead work on single phase or 3-phase AC power.

8. The switching modules 18, 68 (and others) are not limited to IGBT devices and may assume many other forms—including basic mechanical or electromechanical switches.

9. Some switching modules may be combined into a single switching module. For instance, if the embodiment of FIG. 6 is altered so that a single DC bus is fed by both the ORC generator and generator 12, then a single switching module could perform the functions of the two switching modules 18, 68 shown.

10. If asynchronous power generation is used, then the switching modules will need to be able to phase match the power supplied to the grid during periods when the invention is connected to the grid.

11. During periods when a reduced amount of power is needed on the grid, it is possible to switch only one of the electrical power source or ORC engine to the grid while leaving the other connected to the load bank.

Finally, it is important for the reader to understand the overarching objectives of the present invention in order to understand why it is preferable to run the electrical power source (such as biogas engine 36) and the ORC engine continuously (The term “continuously” should be understand to encompass cycles of 30 minutes or more, as opposed to starting and stopping the processes more frequently). A significant objective of the present invention is to boost available power on the electrical grid when the grid voltage falls below a desired level, and to “absorb” excess power on the electrical grid when the grid voltage exceeds a desired level. Another objective is to switch between “boosting” and “absorbing” modes quite rapidly. It is preferable to provide a system than can switch in as little time as a few seconds and even more preferable to provide a switching time of less than 1 second.

Biogas engine 36 and ORC engine 50 are not as difficult to start or stop as a prime mover in a large power plant. Nevertheless, engines of reasonable size do not stop and start in less than one second. And—even if such a rapid response is available—it is undesirable due to increased wear on the components. Thus, it is preferable to leave both the biogas engine and the ORC engine running.

Power produced by the biogas engine is “dumped” into the load bank when it is not needed on the grid. Power produced by the ORC engine is likewise “dumped” into the load bank when it is not needed on the grid. This latter operation may strike the reader as somewhat odd. Thermal energy within the thermal storage unit actually powers the ORC engine. When the output of the ORC generator is applied to the load bank, the ORC engine is simply “dumping” electrical energy back into the source it uses to drive its own evaporator 52. And, since the efficiency of the ORC cycle and electrical generation cycle is substantially less than 100%, it would be more efficient to simply shut down the ORC engine when no “boost” output is needed on the grid.

However, the reader must recall that the efficiency of the storage and retrieval cycles performed by the ORC engine is not the most important objective. Rapid switching time from energy storage to energy production is more important. Thus, it is more important to keep turbine 60 spinning at operational speeds and in a state that is ready to provide suitable torque to the ORC generator 62. In order to do this, it is preferable to keep the ORC generator loaded (meaning that it is producing significant current). The electrical power generated by the ORC generator must be sent somewhere. It is undesirable to place it on the grid at that point—since the grid is in an overvoltage condition—so it is instead sent to the load bank.

Although the preceding description contains significant detail, it should not be construed as limiting the scope of the invention but rather as providing illustrations of the preferred embodiments of the invention. One skilled in the art may easily devise variations on the embodiment of FIG. 6 beyond those described. Thus, the scope of the invention should be fixed by the claims ultimately presented rather than the examples given.

Having described my invention, I claim:

1. A method for reducing power oversupply and undersupply on an electrical distribution grid, comprising:
a. providing an electrical power source;
b. providing a first switching module for selectively connecting said electrical power source to said electrical distribution grid, so that said electrical power source can feed electrical power onto said electrical distribution grid;
c. providing a load bank configured to convert electrical power to heat;
d. providing a thermal storage unit connected to said load bank;
e. providing a second switching module for selectively connecting said electrical power source to said load bank;
f. providing an Organic Rankine Cycle engine, connected to said thermal storage unit so that energy stored in said thermal storage unit can be used to drive said Organic Rankine Cycle engine;
g. providing an ORC generator powered by said Organic Rankine Cycle engine;
h. providing a third switching module for selectively connecting said ORC generator to said electrical distribution grid;
i. providing a fourth switching module for selectively connecting said ORC generator to said load bank;
j. disconnecting said electrical power source and said ORC generator from said grid;
k. connecting said electrical power source and said ORC generator to said load bank in order to send thermal energy to said thermal storage unit; and
l. at a later time disconnecting said electrical power source and said ORC generator from said load bank and connecting said electrical power source and said ORC generator to said grid, whereby thermal energy stored within said thermal storage unit is used to power said Organic Rankine Cycle engine and thereby return a portion of said stored energy to said grid.

2. A method for reducing power oversupply and undersupply as recited in claim 1, wherein said electrical power source is selected from the group consisting of an internal combustion engine, a wind turbine, and a solar panel.

3. A method for reducing power oversupply and undersupply as recited in claim 1, wherein:
a. said first switching module is capable of phase matching said electrical power from said electrical power source to said grid; and
b. said third switching module is capable of phase matching electrical power from said ORC generator to said grid.

4. A method for reducing power oversupply and undersupply as recited in claim 1, wherein:
a. said electrical power source and said ORC generator both feed onto a common bus; and
b. said first and third switching modules are the same switching module, with said switching module being connected to said common bus.

5. A method for reducing power oversupply and undersupply as recited in claim 1, wherein said electrical power source and said ORC engine are both run continuously.

6. A method for reducing power oversupply and undersupply as recited in claim 1, further comprising:
a. defining a target voltage for said electrical distribution grid;
b. when a voltage on said electrical distribution grid exceeds said target voltage, disconnecting said electrical power source and said ORC generator from said grid.

7. A method for reducing power oversupply and undersupply as recited in claim 6, further comprising when a voltage on said electrical distribution grid falls below said target voltage, connecting said electrical power source and said ORC generator to said grid.

8. A method for reducing power oversupply and undersupply on an electrical distribution grid, comprising:
a. providing an electrical power source;
b. providing an Organic Rankine Cycle engine;
c. providing an ORC generator powered by said Organic Rankine Cycle engine;
d. providing at least one load bank;
e. providing at least one thermal storage unit connected to said at least one load bank;
f. wherein said electrical power source can be selectively connected to said grid and can be selectively connected to said at least one load bank;
g. wherein said ORC generator can be selectively connected to said grid and can be selectively connected to said at least one load bank;
h. disconnecting said electrical power source from said grid and connecting said electrical power source to said at least one load bank, thereby sending thermal energy to said at least one load bank;
i. disconnecting said ORC generator from said grid and connecting said ORC generator to said at least one load bank so that said Organic Rankine Cycle engine may continue running while said ORC generator is disconnected from said grid;
j. disconnecting said electrical power source from said at least one load bank and connecting said electrical power source to said grid, thereby delivering power from said electrical power source to said grid; and
k. disconnecting said ORC generator from said at least one load bank and connecting said ORC generator to said grid, thereby delivering energy from said thermal storage unit to said grid.

9. A method for reducing power oversupply and undersupply as recited in claim 8, wherein said electrical power source is selected from the group consisting of an internal combustion engine, a wind turbine, and a solar panel.

10. A method for reducing power oversupply and undersupply as recited in claim 8, wherein:
a. electrical power produced by said electrical power source is phase matched to electrical power on said grid; and
b. electrical power produced by said ORC generator is phase matched to electrical power on said grid.

11. A method for reducing power oversupply and undersupply as recited in claim 8, wherein said electrical power source and said ORC generator both feed onto a common bus.

12. A method for reducing power oversupply and undersupply as recited in claim 8, wherein said electrical power source and said ORC engine are both run continuously.

13. A method for reducing power oversupply and undersupply as recited in claim 8, further comprising:
a. defining a target voltage for said electrical distribution grid; and
b. when a voltage on said electrical distribution grid exceeds said target voltage, disconnecting said electrical power source and said ORC generator from said grid.

14. A method for reducing power oversupply and undersupply as recited in claim 13, further comprising when a voltage on said electrical distribution grid falls below said target voltage, connecting said electrical power source and said ORC generator to said grid.

15. A method for reducing power oversupply and undersupply on an electrical distribution grid, comprising:
a. providing an electrical power source;
b. providing an Organic Rankine Cycle engine;
c. providing an ORC generator powered by said Organic Rankine Cycle engine;
d. providing at least one load bank;
e. providing at least one thermal storage unit connected to said at least one load bank;
f. wherein said electrical power source can be selectively connected to said grid and can be selectively connected to said at least one load bank;
g. wherein said ORC generator can be selectively connected to said grid and can be selectively connected to said at least one load bank;
h. disconnecting at least one selected device of said electrical power source and said ORC generator from said grid and connecting said same selected device to said at least one load bank; and
i. at a later time disconnecting said same selected device from said at least one load bank and connecting said same selected device to said grid.

16. A method for reducing power oversupply and undersupply as recited in claim 15, wherein said electrical power source is selected from the group consisting of an internal combustion engine, a wind turbine, and a solar panel.

17. A method for reducing power oversupply and undersupply as recited in claim 15, wherein:
a. electrical power produced by said electrical power source is phase matched to electrical power on said grid; and
b. electrical power produced by said ORC generator is phase matched to electrical power on said grid.

18. A method for reducing power oversupply and undersupply as recited in claim 15, wherein said electrical power source and said ORC generator both feed onto a common bus.

19. A method for reducing power oversupply and undersupply as recited in claim 15, wherein said electrical power source and said ORC engine are both run continuously.

20. A method for reducing power oversupply and undersupply as recited in claim 15, further comprising:
a. defining a target voltage for said electrical distribution grid;
b. when a voltage on said electrical distribution grid exceeds said target voltage, disconnecting said electrical power source and said ORC generator from said grid.
